(19) United States
(12) Patent Application Publication
(10) Pub. No.: US 2016/0080200 A1
(43) Pub. Date: Mar. 17, 2016

(54) SYSTEM, APPARATUS, AND METHOD OF REGISTERING APPARATUS, AND RECORDING MEDIUM

(71) Applicants: Yukinori ISHII, Kanagawa (JP); Tohru SASAKI, Kanagawa (JP); Tomohiro KUROYANAGI, Kanagawa (JP); Atsushi OKAZATO, Kanagawa (JP); Makoto SASAKI, Kanagawa (JP); Junki AOKI, Kanagawa (JP); Takuya MORI, Tokyo (JP); Hirohisa SAITOH, Tokyo (JP); Mie WATANABE, Tokyo (JP); Tatsuo NISHIMURA, Tokyo (JP)

(72) Inventors: Yukinori ISHII, Kanagawa (JP); Tohru SASAKI, Kanagawa (JP); Tomohiro KUROYANAGI, Kanagawa (JP); Atsushi OKAZATO, Kanagawa (JP); Makoto SASAKI, Kanagawa (JP); Junki AOKI, Kanagawa (JP); Takuya MORI, Tokyo (JP); Hirohisa SAITOH, Tokyo (JP); Mie WATANABE, Tokyo (JP); Tatsuo NISHIMURA, Tokyo (JP)

(73) Assignee: Ricoh Company, Ltd., Tokyo (JP)

(21) Appl. No.: 14/842,900

(22) Filed: Sep. 2, 2015

(30) Foreign Application Priority Data
Sep. 17, 2014 (JP) 2014-188785

(51) Int. Cl. H04L 12/24; H04L 29/12

(52) U.S. Cl. CPC H04L 41/0806; H04L 61/2015; H04L 61/2069

(57) ABSTRACT

A system includes a first apparatus capable of registering a plurality of apparatuses, and a second apparatus connected to the first apparatus via a network. The second apparatus transmits an inquiry request for inquiring presence of a first apparatus capable of registering on the network to all apparatuses on the network by broadcast, and when information indicating an access destination of the first apparatus is received, transmits a registration request for registering the second apparatus to the first apparatus to the received access destination.

### CROSS-REFERENCE TO RELATED APPLICATIONS

This patent application is based on and claims priority pursuant to 35 U.S.C. §119(a) to Japanese Patent Application No. 2014-188785, tiled on Sep. 17, 2014, in the Japan Patent Office, the entire disclosure of which is hereby incorporated by reference herein.

### BACKGROUND

1. Technical Field

The present invention relates to a system, apparatus, and method of registering one or more apparatuses, and a recording medium.

2. Description of the Related Art

There have been known techniques for registering an information processing device as a control target or a management target at another information processing device and controlling or managing the registered information processing device by the other information processing device.

For example, a device management server registers image forming devices and information management devices to manage each of the registered devices.

### SUMMARY

Example embodiments of the present invention include a system, which includes a first apparatus capable of registering a plurality of apparatuses, and a second apparatus connected to the first apparatus via a network. The second apparatus transmits an inquiry request for inquiring presence of a first apparatus capable of registering on the network to all apparatuses on the network by broadcast, and when information indicating an access destination of the first apparatus is received, transmits a registration request for registering the second apparatus to the first apparatus to the received access destination.

Example embodiments of the present invention include an apparatus that operates as the first apparatus, an apparatus that operates as the second apparatus, a method performed by the first apparatus, a method performed by the second apparatus, and a non-transitory recording medium storing a program for operation of registering.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration of an image forming system as an embodiment of an information processing system according to the present invention;

FIG. 2 is a diagram illustrating a hardware configuration of an MFP of the system illustrated in FIG. 1;

FIG. 3 is a diagram illustrating a functional configuration of the MFP as a master apparatus and the MFP as a slave apparatus of the image forming system of FIG. 1;

FIG. 4 is a diagram illustrating an example of a registration destination selection screen;

FIGS. 5A and 5B (FIG. 5) are a sequence diagram illustrating operation of registering an MFP, performed by the image forming system illustrated in FIG. 1, according to an embodiment of the present invention;

FIG. 6 is a diagram illustrating an example of a reference setting screen;

FIG. 7 is a diagram illustrating an example of a deletion notification screen;

FIG. 8 is a diagram illustrating another example of a registration destination selection screen; and

FIG. 9 is a sequence diagram illustrating operation of confirming presence of the MFP on the network, according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

To register one information processing device at another information processing device, the one information processing device desirably makes access to the information processing device as a registration destination to transmit information on the one information processing device to the registration destination. This saves the user from having to manually input the information on the one information processing device to the information processing device as the registration destination.

However, for such transmission of the information, the one information processing device needs to grasp information for access to the information processing device as the registration destination. This requires setting of the information for access in the one information processing device.

In this regard, the internet protocol (IP) address of a device management server may be stored in a dynamic host configuration protocol (DHCP) server in a client environment. The devices located in the client environment search for the DHCP server though network communications. Accordingly, by providing the function of inquiring of the found DHCP server as to the IP address of the device server, the devices including a device newly located in the client environment can acquire automatically the IP address of the device management server.

In this configuration, however, it is necessary to manually register the address of the device management server at the DHCP server. Therefore, the operator needs to have sufficient knowledge to the setting work. The operator also needs the authority to make changes to the setting contents of the DHCP server.

Accordingly, for registration of an information processing device at another information processing device, it is desired that the information processing device to be registered can be registered even if the destination of the access to the information processing device as a registration destination is not known.

Embodiments of the present invention will be described with reference to the accompanying drawings.

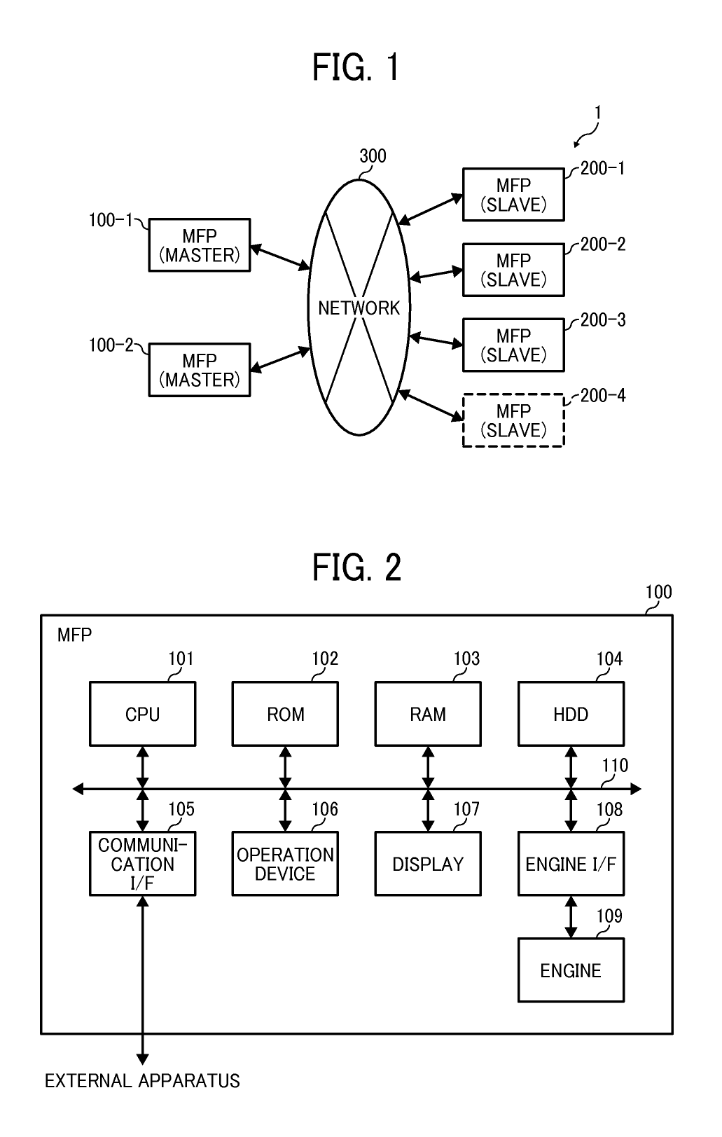

FIG. 1 is a diagram illustrating a configuration of an image forming system as an embodiment of an information processing system according to the present invention.

An image forming system 1 illustrated in FIG. 1 is configured such that a plurality of MFPs 100 as first information processing devices and a plurality of MFPs 200 as second information processing devices are communicably connected to one another via a network 300. Although the MFPs 100 are illustrated with reference signs 100-1 and 100-2 in FIG. 1, the MFPs 100 will be indicated simply with reference sign 100 when it is not necessary to identify the individual devices. Although, the MFPs 200 are illustrated with reference signs 200-1 to 200-4 in FIG. 1, the MFPs 200 will be indicated simply with reference sign 200 when it is not necessary to identify the individual devices.

The MFPs 100 and the MFPs 200 are image forming devices with various functions of copying, printing, scanning, facsimile communications, document accumulation, and the like. However, the MFPs 100 and MFPs 200 are different in that the MFPs 100 function as master apparatuses that make requests for cooperative operations described later to slave apparatuses, and MFPs 200 function as slave apparatuses to which the requests are transmitted.

In relation to the first embodiment, descriptions will be mainly given as to the function of registering a slave apparatus at a master apparatus, and the devices are separated into master apparatuses and slave apparatuses. However, the MFPs 100 and the MFPs 200 may not be different in device type or included hardware. In contrast, the plurality of MFPs 200 may be different from each other in functions except for the function of slave apparatus described above. For example, one of the devices may include both an image reading unit for reading an original image and an image forming unit for forming an image on a recording medium, and the other device may include only one of these units. This matter is also applicable to the plurality of MFPs 100.

The network 300 may be any communication path, regardless of wired or wireless form, that allows broadcasting by which information is transmitted to all of the devices on the network 300.

When a slave apparatus is registered at any of the master apparatuses constituting the image forming system 1, the slave apparatus can be freely added to the image forming system 1. The slave apparatus can be removed from the image forming system 1 by deregistering it or disconnecting it from the network 300 for a long period of time. FIG. 1 illustrates the MFP 200-4 by a dash line because the MFP 200-4 will be taken later to describe the addition of a device to the image forming system 1 and the removal of a device from the image forming system 1.

When a master apparatus is simply connected to the network 300 and becomes capable of receiving broadcast from slave apparatuses, the master apparatus can be regarded as being added to the image forming system 1. In contrast, when being disconnected from the network 300, the master apparatus can be regarded as being removed from the image forming system 1.

FIG. 2 is a diagram illustrating a hardware configuration of the MFP 100 illustrated in FIG. 1.

As illustrated in FIG. 2, each of the MFPs 100 includes a CPU 101, a ROM 102, a RAM 103, a hard disc drive (HDD) 104, a communication interface (I/F) 105, an operation device 106, a display 107, and an engine I/F108, which are connected to one another by a system bus 110. The engine I/F 108 is connected to an engine 109.

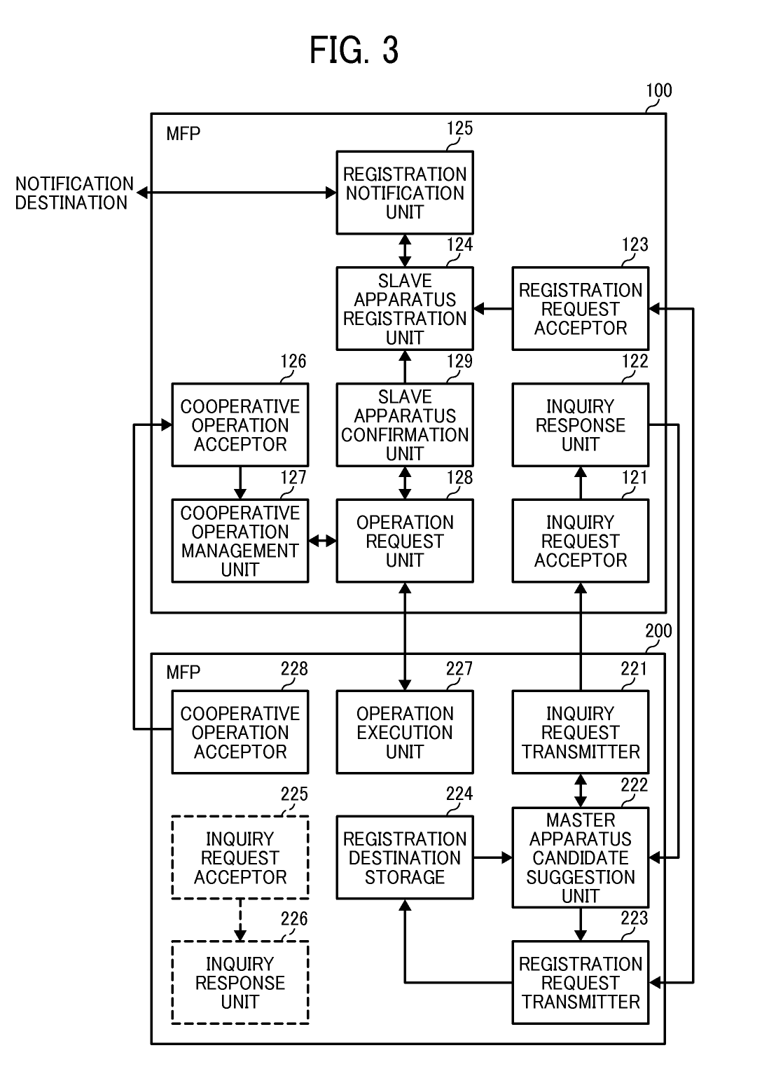

The CPU 101 executes programs, which is loaded from the ROM 102 or the HDD 104 onto the RAM 103 functioning as a work area, to control the entire MFP 100 to perform various functions described later with reference to FIG. 3 and other functions. For example, the functions include the function of, in response to an inquiry request from the MFP 200, transmitting to the MFP 200 the information indicating that the MFP 100 is a master apparatus and the information for access to the MFP 100, and the function of registering the MFP 200 in response to a registration request from the MFP 200.

The ROM 102 and the HDD 104 are non-volatile recording medium that store various programs to be executed by the CPU 101 and various kinds of data described later.

The communication I/F 105 is an interface for communications with other devices such as the MFPs 200 via the network 300. The communication I/F 105 is in compliance with the standards for the network 300.

The operation device 106 accepts instructions from the user. The operation device 106 includes various buttons and switches, and a touch panel for accepting operations on a graphical user interface (GUI) displayed on the display 107 as a user instruction.

The display 107 displays the GUI described above to the user, the operational state or setting contents of the MFP 100, and includes a liquid display and a lamp, and the like. When the MFP 100 does not need to directly accept user instructions (the MFP 100 can accept instructions from an external device connected via the communication I/F 105 and provide information to the external device), the operation device 106 and the display 107 may be omitted.

The engine I/F 108 is an interface for connecting the engine 109 to the system bus 110 to allow the engine 109 to be controlled by the CPU 101. The engine 109 is a module for achieving functions including mechanical actions, such as an image forming unit that forms an image on paper based on image data and an image reading unit that reads the image on the original and outputs the image data indicative of the contents of the image.

The MFPs 200 include the same hardware configuration as that described above. However, the MFPs 200 may be different from one another in the configuration of the engine 109, processing performance of the CPU 101, the capacity of the memory, according to the model type, as described above.

FIG. 3 is a diagram illustrating a configuration of functions included in the MFP 100 and the MFP 200 illustrated in FIG. 1 relating to cooperative operations of a master apparatus and a slave apparatus and registration of a slave apparatus at a master apparatus. The functions of the components illustrated in FIG. 3 are implemented by the CPU 101 of the MFP 100 or the CPU of the MFP 200 controlling the operations of applicable hardware. In addition, the functions of the MFP 100 is the functions as a master apparatus, and the functions of the MFP 200 are the functions as a slave apparatus.

As illustrated in FIG. 3, the MFP 100 includes an inquiry request acceptor 121, an inquiry response unit 122, a registration request acceptor 123, a slave apparatus registration unit 124, a registration notification unit 125, a cooperative operation acceptor 126, a cooperative operation management unit 127, an operation request unit 128, and a slave apparatus conformation unit 129. These components are implemented by a plurality of instructions, which are executed by the CPU 101 according to programs loaded onto the RAM 103. More specifically, the CPU 101 controls hardware in FIG. 2 according to the programs to have the functional components illustrated in FIG. 3.

Among the foregoing components, the inquiry request acceptor 121 has the function of accepting an inquiry request from the MFP 200 as a slave apparatus, which may be implemented by the communication I/F 105 under control of the CPU 101. The inquiry request is a request for inquiring of each of the devices connected to the network 300 whether the device is a master apparatus capable of registering the MFP 200 as a slave apparatus.

The inquiry response unit 122, which may be implemented by the communication I/F 105 under control of the CPU 101, has the function of transmitting to the source of the inquiry request accepted by the inquiry request acceptor 121, the information indicating that the MFP 100 is a master apparatus, the attribute information on the MFP 100, and the information on destination of access to the MFP 100. In this example, the attribute information includes any information that uniquely identifies the MFP 100. For example, the attribute information includes the name and location of the MFP 100. The destination of access is an IP address, for example.

When the inquiry response unit 122 determines that the MFP 100 is not capable of registering the device having transmitted the inquiry request according to the contents of the accepted inquiry request, the inquiry response unit 122 may return a response indicating that the MFP 10 is not a master apparatus or may make no response.

The registration request acceptor 123, which may be implemented by the instructions of the CPU 101, has the function of accepting a registration request from the MFP 200 as a slave apparatus. The registration request is a request for registration of the MFP 200 at the MFP 100. The registration request includes information to be registered at the MFP 100 such as the name of the MFP 200, the destination of access, the kinds of operations executable by the MFP 200, etc.

The slave apparatus registration unit 124, which may be implemented by the instructions of the CPU 101 in cooperation with a memory, has the function of registering information on the MFP 200 as a slave apparatus to which execution of cooperative operations is to be requested, according to the registration request accepted by the registration request acceptor 123. For example, the salve apparatus registration unit 124 stores in a desired memory such as the RAM 103 information regarding the MFP 200 as the slave apparatus in the form of a table.

The slave apparatus registration unit 124 also has the function of notifying the registration notification unit 125 of the acceptance of the registration request and the contents of the same prior to the registration. Then, according to the notification, the registration notification unit 125 notifies a predetermined notification destination of the acceptance of the registration request and the contents of the same, and requests for an instruction for execution or non-execution of the registration. Upon receipt of the instruction for execution of the registration, the slave apparatus registration unit 124 executes the registration of the MFP 200.

In this example, the predetermined notification destination is an e-mail address of the administrator of a pre-registered MFP 100, for example. Alternatively, the predetermined notification destination may be the display 107. In the former case, the notification is transmitted by e-mail, and in the latter case, the notification is displayed on the screen. The contents of the registration request include the attribute information on the slave apparatus such as address, name, and location. Only part of the information included in the registration request may be notified.

The slave apparatus registration unit 124 also performs the function of, upon completion of registration of the MFP 200, notifying the registration notification unit 125 of completion of registration of the MFP 200. According to the notification, the registration notification unit 125 notifies the same predetermined notification destination of the completion of the registration.

The slave apparatus registration unit 124 also has the function of deregistering the MFP 200 according to a request from the slave apparatus conformation unit 129 described later. After the deregistration, the slave apparatus registration unit 124 notifies the registration notification unit 125 of deregistration. According to the notification, the registration notification unit 125, which may be implemented by the communication I/F 105 under control of the CPU 101, notifies the deregistration to the same predetermined notification destination.

The cooperative operation acceptor 126, which may be implemented by the instructions of the CPU 101, has the function of accepting an instruction for execution of cooperative operations by which, of the MFPs 100 as master apparatuses and the MFPs 200 as slave apparatuses registered at the MFPs 100, a given number of devices are operated in cooperation. The instruction may be accepted from the user via the GUI or the like or may be accepted as an execution request from another device such as the MFP 200. Alternatively, the instruction may be accepted from any other device outside the image forming system 1.

In any case, the instruction for execution of cooperative operations includes the contents of the cooperative operations and the information for specifying the devices to execute the operations. The cooperative operation acceptor 126 passes the accepted execution instruction to the cooperative operation management unit 127.

The cooperative operation management unit 127, which may be implemented by the instructions of the CPU 101 in cooperation with hardware of the MFP 100 such as the engine 109, has the function of managing execution of the cooperative operations according to the execution instruction passed from the cooperative operation acceptor 126. Specifically, the cooperative operation management unit 127 instructs the operation request unit 128 to transmit an operation request to the applicable devices to execute the applicable operations, such that each of the operations specified by the execution instruction can be executed by the devices specified by the execution instruction. The cooperative operation management unit 127 also manages the progress status of the operations according to each of operation requests. In some cases, after completion of an operation according to an operation request, the next operation may be executed based on the result of the previous operation. In other cases, the MFP 100 may execute some of the operations by itself.

As an example of cooperative operations, a device A first reads an image from an original, then a device B processes image data obtained by the reading, and then a device C forms an image based on the processed image data.

The operation request unit 128 has the function of transmitting an operation request to the MFPs 200 to execute operations, according to the instruction from the cooperative operation management unit 127 or the slave apparatus conformation unit 129. The operation request may be a request for simply accessing the MFPs 200 for confirmation of presence.

The slave apparatus conformation unit 129 performs the function of regularly accessing each of the slave apparatuses registered at the slave apparatus registration unit 124 and summarizing the access results. The access is made via the operation request unit 128. The slave apparatus conformation unit 129 also has the function as a deregistration unit to deregister from the slave apparatus registration unit 124 the slave apparatus having made no response in excess of a predetermined standard, according to the results of access to the slave apparatuses. The predetermined standard may be the absence of a response for a predetermined period of time or more, or the absence of a response after a predetermined consecutive number of accesses or more, or the like. The user may set the standard.

Referring to FIG. 3, each of the MFPs 200 includes an inquiry request transmitter 221, a master apparatus candidate suggestion unit 222, a registration request transmitter 223, a registration destination storage 224, an inquiry request acceptor 225, an inquiry response unit 226, an operation execution unit 227, and a cooperative operation acceptor 228. These components are implemented by a plurality of instructions, which are executed by the CPU 101 according to programs loaded onto the RAM 103. More specifically, the CPU 101 controls hardware in FIG. 2 according to the programs to have the functional components illustrated in FIG. 3.

Among the foregoing components, the inquiry request transmitter 221, which may be implemented by the communication I/F 105 under control of the CPU 101, has the function of transmitting an inquiry request to the devices on the network 300 to which the MFP 200 is connected. The transmission may be performed by broadcast so that the inquiry request can be transmitted to all of the devices on the network 300 including the devices of which the addresses are not known.

The master apparatus candidate suggestion unit 222, which may be implemented by the instructions of the CPU 101, has the function of collecting responses from the devices on the network 300 in response to the inquiry requests transmitted by the inquiry request transmitter 221, and of providing the user with the candidates for master apparatuses capable of registering the MFP 200 as a slave apparatus on the registration destination selection screen of the display. The responses to the inquiry request are transmitted from not only the MFPs 100 but also the other MFPs 200. However, the information transmitted from the MFPs 200 indicates that they are slave apparatuses and are incapable of registering another slave apparatus, and thus is not displayed on the registration destination selection screen. That is, the registration destination selection screen is displayed according to the responses from the MFPs 100 as master apparatuses capable of registering the MFP 200 as a slave apparatus.

The inquiry request transmitter 221 and the master apparatus candidate suggestion unit 222 correspond to the inquiry unit.

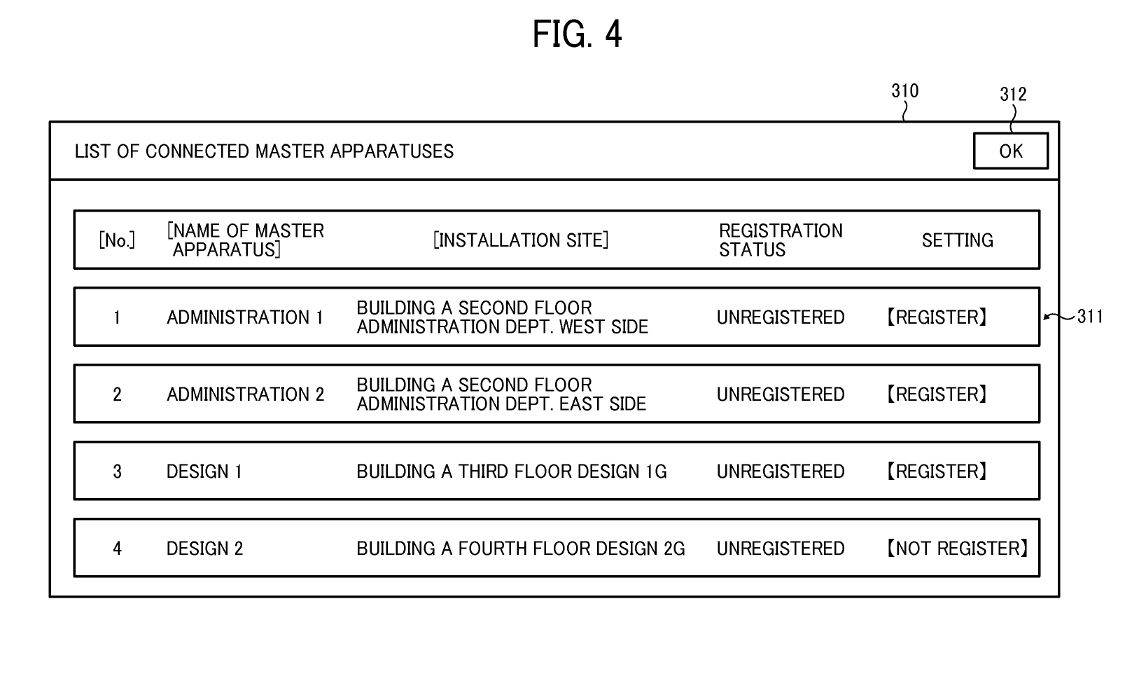

FIG. 4 is a diagram illustrating an example of a registration destination selection screen.

A registration destination selection screen 310 illustrated in FIG. 4 is an example in which responses from four master apparatuses are received. A candidate display 311 includes buttons corresponding to the master apparatuses. Each of the buttons contains attribute information provided by the master apparatus. In the example of FIG. 4, the items “name” and “location (installation site)” correspond to the attribute information. The “name” is the name of the MFP 100, and the “location” describes the location of the MFP 100, such as the site where the MFP 100 is installed. These items are set by the administrator of the MFP 100 and notified by the MFP 100 itself.

The item “No” is an identification number assigned by the master apparatus candidate suggestion unit 222 to uniquely identify each of the master apparatuses.

The item “registration status” indicates whether any MFP 200 is already registered in the applicable master apparatus. The item is displayed depending on the destination of registration stored in the registration destination storage 224.

The item “setting” indicates whether a registration request is to be transmitted to the applicable master apparatus. Pressing the button can toggle between “register” and “not register.”

The registration destination selection screen 310 includes an OK button 312. When the OK button 312 is pressed, the master apparatus candidate suggestion unit 222 decides to transmit a registration request to the master apparatus corresponding to the button with the item “setting” at the “register” position. Then, the master apparatus candidate suggestion unit 222 passes a response from the master apparatus to the registration request transmitter 223 to request for transmission of the registration request to the master apparatus. The passed response includes information on the destination of access to the master apparatus.

Returning to FIG. 3, the registration request transmitter 223, which may be implemented by the communication I/F 105 under control of the CPU 101, has the function as a registration request unit to transmit a registration request to the master apparatus applicable to the request from the master apparatus candidate suggestion unit 222 to register the MFP 200 as a slave apparatus. At the MFP 100 as a master apparatus, the registration request acceptor 123 accepts and processes the request. When confirming by the response from the MFP 100 that the MFP 200 has been registered at the MFP 100, the registration request transmitter 223 stores in the registration destination storage 224 the information on the MFP 100 as information on the registration destination.

The registration destination storage 224, which may be implemented by a memory such as the RAM 103 under control of the CPU 101, has the function of storing information on the master apparatus with the MFP 200 registered as a slave apparatus. The information acquired from the applicable master apparatus as at least a response to the inquiry request is desirably stored in the registration destination storage 224.

The inquiry request acceptor 225 and the inquiry response unit 226, each of which may be implemented by the instructions of the CPU 101, have the function of accepting an inquiry request from another MFP 200 and transmitting a response to the request, in a substantially similar manner as the inquiry request acceptor 121 and the inquiry response unit 122 at the MFP 100 do. However, the response transmitted by the inquiry response unit 226 is information indicating that the MFP 200 is a slave apparatus incapable of registering another slave apparatus. The inquiry response unit 226 does not need to transmit attribute information or information on the destination of access.

Alternatively, the MFP 200 may not be provided with the inquiry request acceptor 225 or the inquiry response unit 226 so that the MFP 200 ignores an inquiry request or return an error message. For this reason, the inquiry request acceptor 225 and the inquiry response unit 226 are shown by dash lines in FIG. 3.

The operation execution unit 227, which may be implemented by the instructions of the CPU 101, has the function of executing an operation requested by the operation request unit 128 and returning the execution result to the operation request unit 128.

The cooperative operation acceptor 228, which may be implemented by the instructions of the CPU 101, has the function of accepting an instruction for execution of cooperative operations as the cooperative operation acceptor 126 does. However, cooperative operations acceptable by the cooperative operation acceptor 228 are operations to be executed by a given number of devices in cooperation, out of the MFP 200, the MFP 100 with the MFP 200 registered as a slave apparatus, and other slave apparatuses registered at the MFP 100. Upon receipt of the instruction for execution of cooperative operations, the cooperative operation acceptor 228 transmits the execution instruction to the MFP 100. At the MFP 100, the cooperative operation acceptor 126 accepts the execution instruction and causes the cooperative operation management unit 127 to execute the cooperative operations.

Next, descriptions will be given as to operations by the devices when a new MFP 200 is installed as a slave apparatus in the image forming system 1 including the MFPs 100 and 200 with the foregoing functions.

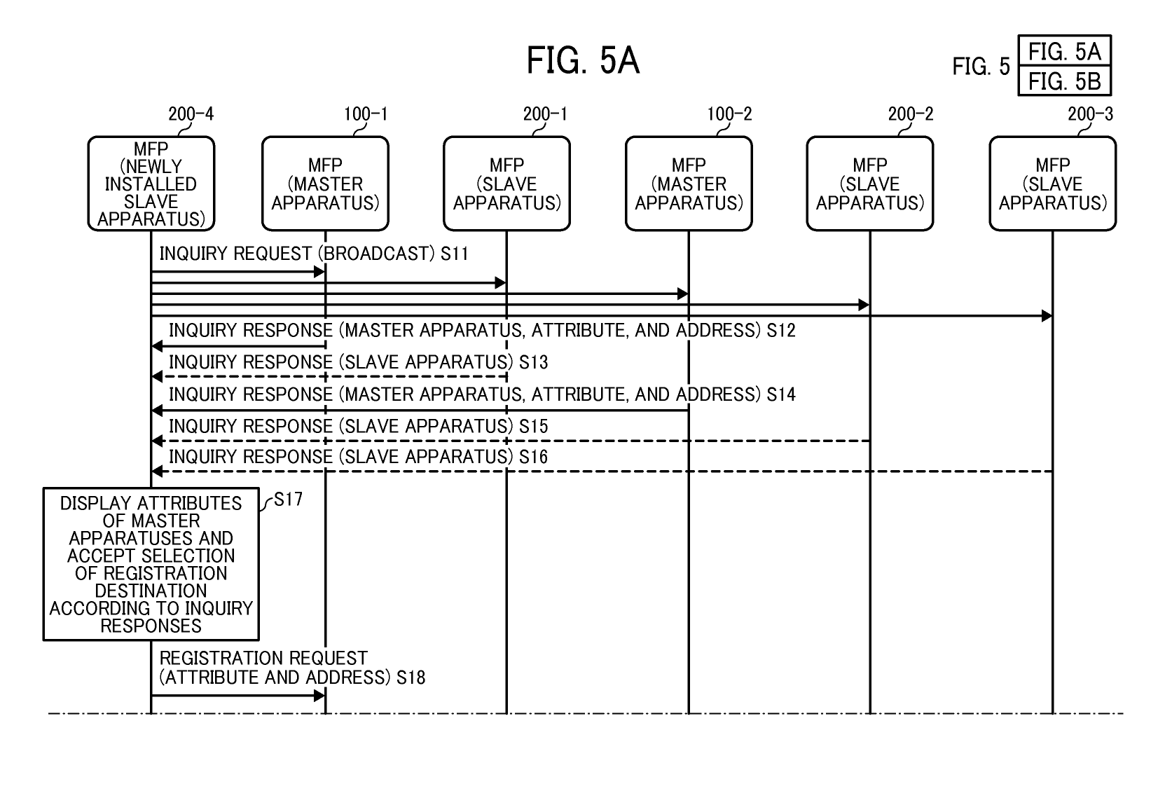

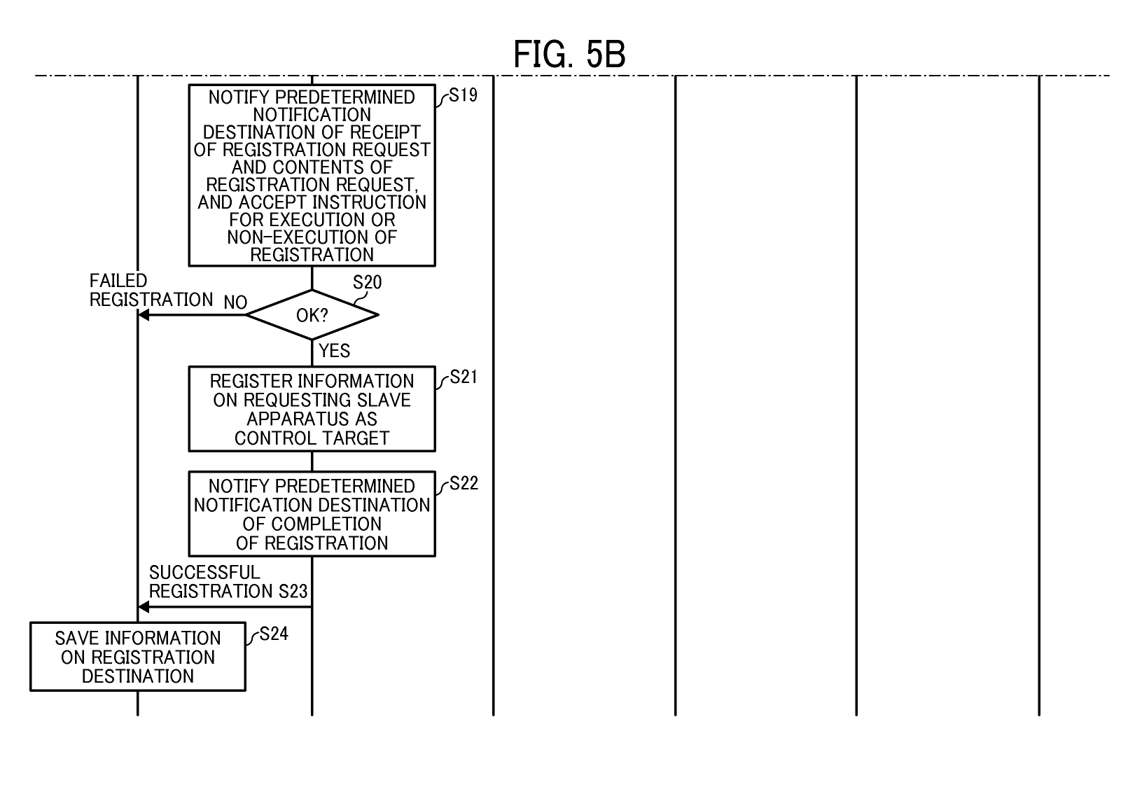

FIG. 5 is a sequence diagram illustrating operation of registering a MFP, performed by the image forming system of FIG. 1, according to an embodiment of the present invention. In FIG. 5, the MFP 200-4 is a newly installed slave apparatus. As for the other devices, all the MFPs 200-1 to 200-3 are registered as slave apparatuses, respectively, at the MFPs 100-1 and 100-2 as master apparatuses.

When detecting connection to the network 300, the MFP 200-4 broadcasts an inquiry request to the devices on the network 300 as illustrated in FIG. 5 (S11). This operation corresponds to the function of the inquiry request transmitter 221. Step S11 constitutes an inquiry procedure together with the following steps S12 to S16.

Each of the devices having received the inquiry request transmits an inquiry response to the MFP 200-4 as a transmission source (S12 to S16). At that time, each of the MFPs 100-1 and 100-2 as master apparatuses transmits an inquiry response including the information indicating that it is a master apparatus, the attribute information on it, and the address as the destination of access to it. Each of the MFPs 200-1 to 200-3 as slave apparatuses transmits an inquiry response including the information indicating that it is a slave apparatus. The slave apparatuses may simply ignore the inquiry request or return an error message as described above. For this reason, the inquiry responses from the slave apparatuses are shown by dash lines in FIG. 5.

Steps S12 and S14 are steps in the inquiry response procedure at the master apparatus side, which correspond to the function of the inquiry response unit 122. Steps S13, S15, and S16 correspond to the function of the inquiry response unit 226 at the slave apparatus side.

After waiting for the responses for a predetermined period of time, the MFP 200-4 displays, on the display 107, the attributes of the master apparatuses on the registration destination selection screen 310 according to the inquiry responses from the master apparatuses. The MFP 200-4 accepts selection of the registration destination, which is received as a user selection (S17). The MFP 200-4 transmits a registration request to the address included in the inquiry response from the selected registration destination (S18). The registration request describes the attribute information on the MFP 200-4 and the address of the same. In the example of FIG. 5, the MFP 100-1 is selected. Step S17 corresponds to the function of the master apparatus candidate suggestion unit 222, and step S18 corresponds to the function of the registration request transmitter 223. In addition, step S18 constitutes the registration request procedure.

Upon receipt of the registration request, the MFP 100-1 notifies the receipt of the registration request and the contents of the same to a predetermined notification destination, and accepts an instruction for execution or non-execution of registration from the notification destination (S19). When the instruction indicates execution of the registration (S20: Yes), the MFP 100-1 registers the information on the slave apparatus as the source of the registration request (MFP 200-4 in this example) as a control target (S21), and notifies the predetermined notification destination (S22) of registration of the salve apparatus (MFP 200-4). The MFP 100-1 also notifies the source of the registration request that the registration is successfully completed (S23). On the other hand, when the instruction does not indicate execution of the registration is successful, the MFP 100-1 notifies the slave apparatus (MFP 220-4) as the source of the registration request that the registration is failed.

Steps S19 to S23 constitute the registration procedure, which correspond to the functions of the slave apparatus registration unit 124 and the registration notification unit 125.

Upon receipt of the notification of the successful registration, the MFP 200-4 saves the information on the registration destination having transmitted the notification (S24), and ends the registration operation. Step S24 corresponds to the function of the registration destination storage 224.

In the case of registering the MFP 200-4 at a plurality of master apparatuses, steps S19 to S24 are carried out for each of the master apparatuses.

According to the foregoing operations, in response to an inquiry request broadcast by a slave apparatus, a master apparatus transmits to the source of the inquiry request, the information indicating that the device is a master apparatus and the information on the destination of access to the master apparatus. Accordingly, even if the destination of access to the master apparatus is not registered at the slave apparatus, the slave apparatus can recognize the destination of access to the master apparatus and transmit a registration request to the master apparatus. In addition, there is no need to register the destination of access to the master apparatus at any other device other than the master apparatus. This saves the user from having to make environmental settings for registering the slave apparatus at the master apparatus. Through the above-described operation, the slave apparatus can access the master apparatus even if the slave apparatus does not have the address of the master apparatus.

Further, upon receipt of a registration request from the slave apparatus, the master apparatus notifies the predetermined notification destination of the receipt of the registration request and the contents of the same, and executes the registration when receiving an instruction for execution of the registration from the notification destination. Therefore, the administrator and the like of the master apparatus can recognize in advance the slave apparatus to be registered and exclude invalid registration requests.

Upon execution of registration of the slave apparatus, the master apparatus notifies the predetermined notification destination of registration of the salve apparatus, and thus the administrator or the like of the master apparatus can recognize the actually registered slave apparatus.

In the operations described in FIG. 5, step S17 may be omitted. That is, the registration request may be automatically transmitted to the master apparatus having transmitted the inquiry response. When a plurality of master apparatuses transmits an inquiry response, one of the master apparatuses may be selected by the use of an appropriate algorithm so that the registration request is transmitted to the selected master apparatus. This further reduces operation loads on the user in a system in which registration at a master apparatus can be made with no special risk.

Next, descriptions will be given as to operations regularly performed by the MFP 100 as a master apparatus in relation to presence confirmation of slave apparatuses.

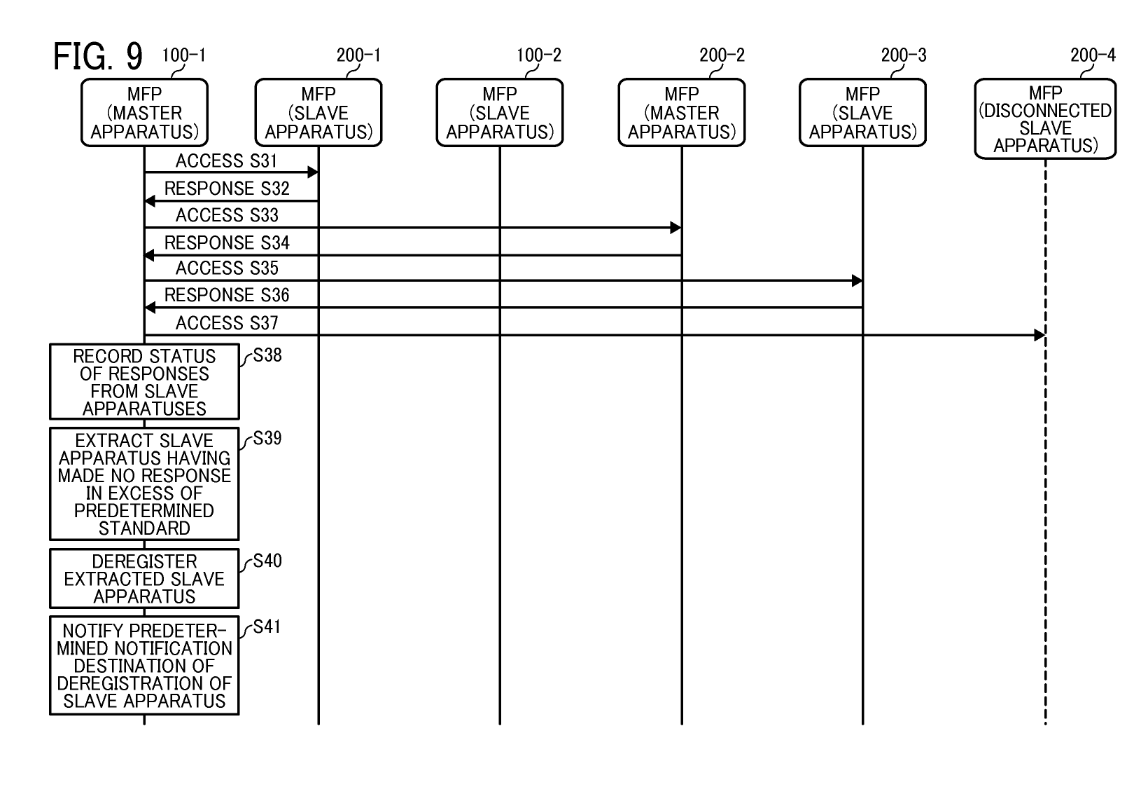

FIG. 9 is a sequence diagram illustrating operation of confirming presence of the devices, performed by the master apparatus such as the MFP 100-1, according to an embodiment of the present invention.

The MFP 100-1 regularly accesses the slave apparatuses registered at the MFP 100-1 for presence confirmation as illustrated in FIG. 9. In this example, the MFPs 200-1 to 200-4 are registered at the MFP 100-1, and the MFP 100-1 accesses each of these slave apparatuses (S31, S33, S35, and S37). The MFP 100-1 does not access the MFP 100-2 because the MFP 100-2 is not registered at the MFP 100-1.

Of the transmission destinations, the MFPs 200-1 to 200-3 connected to the network 300 accept the access and return a response to the access (S32, S34, and S36). The access may mean transmitting a predetermined operation request or merely transmitting a ping, as far as the target MFPs 200 connected to the network 300 can return a response to the access.

In this example, the MFP 200-4 is disconnected from the network 300. In such case, the MFP 200-4 accepts no access or returns no response.

The foregoing operations correspond to the functions of the slave apparatus conformation unit 129, the operation request unit 128, and the operation execution unit 227.

Next, the MFP 100-1 records the status of responses from the slave apparatuses (S38). The MFP 100-1 may record which of the slave apparatuses made a response to which of the accesses. Then, the MFP 100-1 extracts a slave apparatus having made no response in excess of a predetermined standard (S39), and deregisters the extracted slave apparatus (S40). These operations correspond to the functions of the slave apparatus conformation unit 129 and the slave apparatus registration unit 124.

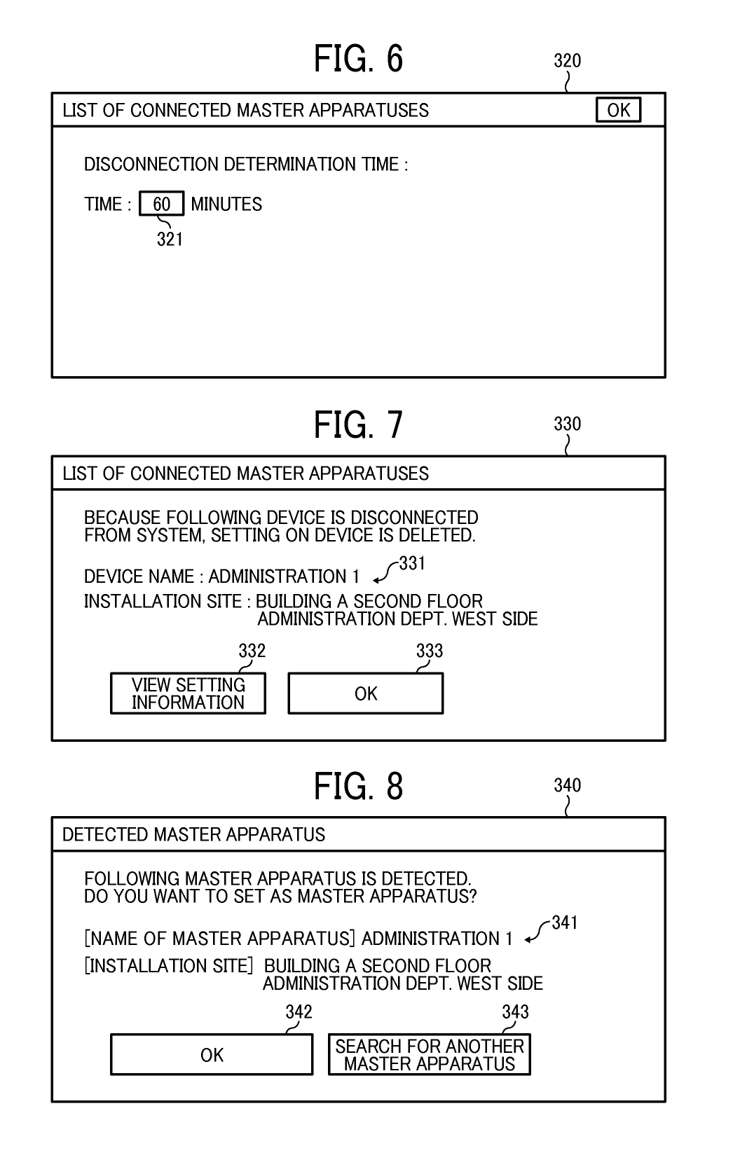

The predetermined standard here may be a predetermined period of time or more, a predetermined number or more of times the access is made, or the like. This standard may be set by the user on a screen such as a reference setting screen 320 illustrated in FIG. 6, for example. On the reference setting screen 320, the user can enter a numeral indicating minutes into a time setting unit 321 such that the registration is deleted when no response is made for the entered minutes or more. In the example of FIG. 6, 60 minutes are set. Alternatively, one to several days may be set in environments where the slave apparatus may be turned off and incapable of making any response.

Returning to FIG. 9, when deregistering any slave apparatus at step S40, the MFP 100-1 notifies the predetermined notification destination (S41) of deregistration, and the operation of FIG. 9 ends. The operation at step S41 corresponds to the functions of the slave apparatus conformation unit 129 and the slave apparatus registration unit 124. The notification may be made in various manners such as transmission of e-mail or display on a screen as described above.

In the case of making the notification by display on the screen, for example, the notification may be displayed on a deletion notification screen 330 illustrated in FIG. 7, for example. On the deletion notification screen 330, the attribute information on the deregistered slave apparatus is displayed at a deleted device display 331. A view setting information button 332 is a button for displaying, when selected, detailed information on the slave apparatus in the previously registered state. Information displayed according to operation on the button may include the address of the slave apparatus, the apparatus type, the registration status of cooperative operations to be performed with the slave apparatus, and the like. The OK button 333 is a button for closing the deletion notification screen 330.

According to the actions described in FIG. 9, the master apparatus regularly makes access to the slave apparatuses registered at the master apparatus, and deregisters any slave apparatus having made no response in excess of the predetermined standard based on the access results. Therefore, even when a slave apparatus is disconnected from the image forming system 1 without any explicit request for deregistration from the slave apparatus, the master apparatus can easily recognize the disconnection and execute the deregistration. It is desired that the deregistration can be quickly executed in such a manner as described above because, when any slave apparatus not existing in the system remains registered at the master apparatus, the slave apparatus is unfavorably included in candidates for devices to execute cooperative operations. Even when any slave apparatus is deregistered simply because it is tuned off or the like, there is no major inconvenience because re-registration is easy to made.

In addition, upon deregistration of a slave apparatus, the master apparatus notifies the predetermined notification destination of the deregistration, and therefore the administrator or the like of the master apparatus can easily grasp the registration status of the slave apparatuses.

The specific configurations of the devices, the specific operating procedures, the number of the devices, the purposes of registration, and the like are not limited to those described above in relation to the embodiments.

For example, at step S17 described in FIG. 5, the MFP 200-4 may not provide the user with responses from master apparatuses only after (almost) all of the responses are collected, but may provide the user with a response from at least one master apparatus upon receipt of the response to ask the user for an instruction for execution of registration or not.

FIG. 8 is a diagram illustrating another example of a registration destination selection screen.

On a registration destination selection screen 340 illustrated in FIG. 8, attribute information on the master apparatus having first returned a response to the inquiry request is displayed at a candidate display 341. Then, when the OK button 342 is pressed, the MFP 200-4 recognizes that an instruction of transmission of a registration request to the displayed master apparatus is received, and moves to step S18 and the following steps. All subsequent responses to the inquiry request may be ignored.

When a search for another master apparatus button 343 is pressed, the MFP 200-4 continues to wait for a response to the inquiry request from the other master apparatus. Upon receipt of any response from another master apparatus, the MFP 200-4 displays again the registration destination selection screen 340 according to the contents of the response.

When no response is received after a lapse of a predetermined period of time from the transmission of the inquiry request, the MFP 200-4 may display a message indicating that no other candidate for master apparatus is found.

According to the foregoing configurations, it is possible to select a master apparatus at which the slave apparatus is to be registered from among a given number of master apparatuses connected to the network 300, as in the case of using the screen illustrated in FIG. 4. This configuration is useful in the case where a slave apparatus is to be registered at once in only one master apparatus.

Upon receipt of a response from the master apparatus at which the MFP 200-4 is already registered, the master apparatus may be omitted from the display on the registration destination selection screen 340. This is because it is meaningless to transmit a registration request again to the master apparatus at which the slave apparatus is already registered.

As described above, in at least one of the foregoing embodiments, it is possible to register one information processing device in another information processing device even if the information processing device to be registered does not recognize the destination of access to the information processing device as a registration destination.

In the foregoing embodiments, the image forming system includes pluralities of master apparatuses and slave apparatuses. Alternatively, the system may include only one master apparatus. As far as the master apparatus allows registration of a plurality of slave apparatuses, the number of a slave apparatus registered at the master apparatus may be zero or one at a certain point of time.

When there is no need for the master apparatuses to perform cooperative operations, it may be considered that one image forming system is formed by each of the master apparatuses on the network 300 and slave apparatuses registered at the master apparatus.

In the foregoing embodiments, the master apparatuses and the slave apparatuses execute cooperative operations. Alternatively, each of the master apparatuses may register slave apparatuses to establish the relationship between the master apparatus and the slave apparatuses in which the master apparatus controls the slave apparatuses or the master apparatus manages the slave apparatuses.

In the foregoing embodiment, the master apparatuses and the slave apparatuses are image forming devices. Alternatively, the master apparatuses and the slave apparatuses may be devices having any functions and hardware as far as they are communicable to each other. For example, the master apparatuses and the slave apparatuses may be information processing devices such as general-purpose computers.

In addition, one device may be provided with both the functions as a master apparatus and as a slave apparatus for simultaneous printing.

An embodiment of a program according to the present invention is a program for causing a computer to control desired hardware to realize the functions of the MFP 100 or the MFP 200 in the foregoing embodiments (in particular, the functions described in FIG. 3).

This program may be stored in advance in a ROM included in the computer or another non-volatile storage medium (a flash memory, an EEPROM, or the like). Alternatively, the program may be provided in the state of being recorded in any non-volatile recording medium such as a memory card, a CD, a DVD, or a Blu-ray disc. The program recorded in the recording medium can be installed into the computer and executed on the same, thereby to execute the foregoing operational procedures.

The program may be downloaded from an external device connected to a network and including a recording medium recording the program or an external device in which the program is stored in a storage, and may be installed into the computer and executed on the same.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. A system, comprising:
a first apparatus capable of registering a plurality of apparatuses on a memory; and
a second apparatus connected to the first apparatus via a network, the first apparatus and the second apparatus each of which being an information processing apparatus, wherein
the first apparatus is configured to,
in response to an inquiry request for inquiring presence of a first apparatus capable of registering on the network from the second apparatus, send information indicating that the first apparatus is capable of registering and information indicating an access destination of the first apparatus, and
in response to a registration request for registering the second apparatus from the second apparatus, register the second apparatus on the memory, and the second apparatus is configured to,
transmit the inquiry request to all apparatuses on the network by broadcast,
receive the information indicating the access destination of the first apparatus capable of registering, and
transmit the registration request for registering the second apparatus to the first apparatus, to the received access destination of the first apparatus.

2. The system of claim 1, wherein, when the first apparatus includes a plurality of first apparatuses,
each one of the plurality of first apparatuses further transmits attribute information of the first apparatus to the second apparatus in response to the inquiry request, and
the second apparatus causes a display to display the attribute information of each one of the first apparatuses, and receives a user selection of one of the plurality of first apparatuses based on the attribute information, as the first apparatus to which the registration request is to be transmitted.

3. The system of claim 1, wherein
the first apparatus further transmits information indicating that the registration request is received and contents of the registration request, to a preset destination to request for approval of registration, and
when the response indicating approval of registration is received from the preset destination, the first apparatus registers the second apparatus on the memory.

4. The system of claim 3, wherein
the first apparatus transmits information indicating registration of the second apparatus to the preset destination.

5. The system of claim 1, wherein
the first apparatus periodically accesses each one of a plurality of second apparatuses that are registered to the first apparatus, and
deletes at least one of the plurality of second apparatuses having no response for at least a predetermined time period.

6. The system of claim 5, wherein
the first apparatus transmits information indicating deregistration of the at least one second apparatus to a preset destination.

7. The system of claim 1, wherein
the first apparatus registers a plurality of image forming apparatuses as the second apparatus, which are capable of operating in cooperation to perform one job.

8. The system of claim 2, wherein the attribute information includes a name and a location of the first apparatus.

9. An information processing apparatus connected to a network, comprising:
a transmitter that transmits an inquiry request for inquiring presence of an apparatus capable of registering to all apparatuses on the network by broadcast; and
a receiver that receives information indicating an access destination of the apparatus capable of registering, from the apparatus capable of registering on the network,
wherein the transmitter transmits a registration request for registering the information processing apparatus to the apparatus capable of registering, to the received access destination of the apparatus capable of registering.

10. The information processing apparatus of claim 9, wherein, when the apparatus capable of registering includes a plurality of apparatuses capable of registering, the information processing apparatus further comprising:
a display that displays attribute information of each one of the plurality of apparatuses capable of registering, the attribute information being received in response to the inquiry request; and
an operation device that receives a user selection of one of the plurality of apparatuses capable of registering based on the attribute information, as the apparatus to which the registration request is to be transmitted.

11. A non-transitory recording medium which, when executed by one or more processors, cause the processors to perform a registration method comprising:
transmitting an inquiry request for inquiring presence of an apparatus capable of registering to all apparatuses on the network by broadcast;
receiving information indicating an access destination of the apparatus capable of registering, from the apparatus capable of registering on the network; and
transmitting a registration request for registering the information processing apparatus to the apparatus capable of registering, to the received access destination of the apparatus capable of registering.

12. The non-transitory recording medium of claim 11, wherein, when the apparatus capable of registering includes a plurality of apparatuses capable of registering, the method further comprising:
receiving attribute information of each one of the plurality of apparatuses capable of registering from each one of the plurality of apparatuses in response to the inquiry request;
displaying, on a display, the attribute information of each one of the plurality of apparatuses capable of registering; and
receiving a user selection of one of the plurality of apparatuses capable of registering based on the attribute information, as the apparatus to which the registration request is to be transmitted.
